(19) United States
(12) Patent Application Publication
(10) Pub. No.: US 2026/0119669 A1
(43) Pub. Date: Apr. 30, 2026

(54) FIRMWARE EXECUTION METHOD, DEVICE AND SYSTEM, STORAGE MEDIUM, AND ELECTRONIC DEVICE

(71) Applicant: SUZHOU METABRAIN INTELLIGENT TECHNOLOGY CO., LTD., Suzhou, Jiangsu (CN)

(72) Inventors: Lin YANG, Suzhou, Jiangsu (CN); Fanyi YAO, Suzhou, Jiangsu (CN); Zhaonan NING, Suzhou, Jiangsu (CN); Zhen YANG, Suzhou, Jiangsu (CN); Xiuqiang SUN, Suzhou, Jiangsu (CN)

(73) Assignee: SUZHOU METABRAIN INTELLIGENT TECHNOLOGY CO., LTD., Suzhou, Jiangsu (CN)

(21) Appl. No.: 19/469,732

(22) PCT Filed: Dec. 6, 2024
(86) PCT No.: PCT/CN2024/137545

§ 371 Date: Nov. 3, 2025

(30) Foreign Application Priority Data
Dec. 28, 2023 (CN) 202311839060.8

(51) Int. Cl. G06F 21/57

(52) U.S. Cl. CPC G06F 21/572

(57) ABSTRACT

Provided are a method, apparatus, and system of executing firmware, a non-volatile readable storage medium, and an electronic apparatus. The method of executing firmware is applied to a server. The server includes: a central processing unit, a southbridge controller connected to the central processing unit, a trusted platform module connected to the southbridge controller, and a board management controller connected to the southbridge controller. The method includes: performing digital signature verification on target firmware of an input/output system; in a case where the digital signature verification on the target firmware succeeds, obtaining first trusted measurement information of the target firmware and determining a verification result of verification on the first trusted measurement information; and determining, based on the verification result, whether to execute the target firmware.

### CROSS-REFERENCE TO RELATED APPLICATIONS

This application is a National Stage Entry under 35 U.S.C. § 371 of PCT International Application No. PCT/CN2024/137545, filed on Jun. 12, 2024, which claims priority to Chinese Patent Application No. 202311839060.8, entitled “METHOD, APPARATUS, AND SYSTEM OF EXECUTING FIRMWARE, STORAGE MEDIUM, AND ELECTRONIC APPARATUS” filed with the China National Intellectual Property Administration on Dec. 28, 2023, the entire contents of each of which are incorporated herein by reference for all purposes

### TECHNICAL FIELD

Embodiments of the present application relate to the field of communications, and in particular, to a method, apparatus, and system of executing firmware, a non-volatile readable storage medium, and an electronic apparatus.

### BACKGROUND

A basic input output system (BIOS) is a group of programs that are solidified onto a flash read only memory (Flash ROM) of a board. The BIOS stores a basic input/output program, a power-on self-test program, a system startup program, and system settings information that are the most important programs of a computer. As a manager of the lowest-level and most direct hardware setting and control process of a server board, the BIOS provides many usability functions for a server.

With the development of network technologies, the threat to network security is becoming increasingly serious. Due to an ability of providing the lowest-level and most direct hardware setting and control function for the computer, the BIOS has an execution priority higher than that of an operating system. Assuming that BIOS firmware is damaged and tampered with by hackers, it can cause irreparable data loss and even hardware loss. To address the aforementioned security threats and fix security vulnerabilities in the firmware itself, it is necessary to regularly update a firmware version.

In order to ensure the integrity of BIOS firmware update and prevent the BIOS firmware from being tampered with, the following three methods are usually used for the server in the existing art: 1) The first method is to add a trusted platform module (TPM). The TPM is a secure encryption processor designed to perform an encryption operation on BIOS firmware or software. To verify the trustworthiness of firmware or software, the TPM is usually installed on the server. A TPM technology can provide hardware-based security-related functions. The TPM includes a plurality of physical security mechanisms for preventing the BIOS firmware or software from being tampered with, so that malicious software cannot tamper with related functions of the TPM. Therefore, the TPM can be used to verify a firmware signature to ensure the integrity of the BIOS firmware update and prevent the BIOS firmware from being tampered with. However, this method may have a problem that a security mechanism is completely ineffective in case of manufacturer key leakage. 2) The second method is to use a platform firmware resilience (PFR) technology. The PFR technology requires a high-specification field programmable gate arrays (FPGA) or complex programmable logic devices (CPLD) for hardware integrity verification to prevent the BIOS firmware from being tampered with. However, the second method may bring the following problems: the high-specification FPGA is expensive, which brings high costs. Furthermore, a PFR function is relatively complex to use, which is not conducive to maintenance and use in a later stage. 3) The third method is a method for implementing BIOS dynamic measurement based on a board management controller (BMC). In this method, a read/write bus of a basic input/output system flash (BIOS Flash) in the BIOS needs to be regularly switched to the BMC for verification. This method may make a host system not function when the BIOS Flash is switches to the BMC, leading to a brief halt in host service and thus being detrimental to user services.

In the existing art, a verification mode for input/output system firmware is relatively simple and still has a risk of undetected firmware tampering, which poses a security risk to the server. This problem has not been effectively solved.

### SUMMARY

The embodiments of the present application provide a method, apparatus, and system of executing firmware, a non-volatile readable storage medium, and an electronic apparatus, to at least solve the following problem in the related art: a verification mode for input/output system firmware is relatively simple and still has a risk of undetected firmware tampering, which poses a security risk to the server.

According to one embodiment of the present application, a method of executing firmware is provided, which is applied to a server. The server includes: a central processing unit, a southbridge controller connected to the central processing unit, a trusted platform module connected to the southbridge controller, and a board management controller connected to the southbridge controller. The method includes: performing digital signature verification on target firmware of an input/output system, where the input/output system is a system that is run in the central processing unit; in a case where the digital signature verification on the target firmware succeeds, obtaining first trusted measurement information of the target firmware, and determining a verification result of verification on the first trusted measurement information; and determining, based on the verification result, whether to execute the target firmware.

In one exemplary embodiment, the determining a verification result of verification on the first trusted measurement information includes: determining whether the first trusted measurement information and second trusted measurement information generated by a first terminal are consistent, wherein the second trusted measurement information is generated by the first terminal based on the target firmware; and determining the verification result based on whether the first trusted measurement information and the second trusted measurement information are consistent.

In one exemplary embodiment, the determining the verification result based on whether the first trusted measurement information and the second trusted measurement information are consistent includes: in a case where the first trusted measurement information and the second trusted measurement information are consistent, determining that the verification result indicates that the verification on the first trusted measurement information succeeds; and in a case where the first trusted measurement information and the second trusted measurement information are not consistent, determining that the verification result indicates that the verification on the first trusted measurement information fails.

In one exemplary embodiment, the obtaining first trusted measurement information of the target firmware includes: obtaining a plurality of pieces of third trusted measurement information, which comprise third trusted measurement information of each sub firmware in the target firmware, and fourth trusted measurement information of the target firmware as a whole, wherein the first trusted measurement information includes: the plurality of pieces of the third trusted measurement information and the fourth trusted measurement information; the each sub firmware is partial firmware in the target firmware; and the each sub firmware is configured to execute one function.

In one exemplary embodiment, the determining a verification result of verification on the first trusted measurement information includes: determining a plurality of pieces of fifth trusted measurement information and six trusted measurement information from the second trusted measurement information generated by a first terminal, wherein the plurality of pieces of the fifth trusted measurement information comprise fifth trusted measurement information generated by the first terminal based on the each sub firmware in the target firmware, and the sixth trusted measurement information is generated by the first terminal based on the target firmware as a whole; and determining the verification result based on the plurality of pieces of third trusted measurement information, the fourth trusted measurement information, the plurality of pieces of fifth trusted measurement information, and the sixth trusted measurement information.

In one exemplary embodiment, the determining the verification result based on the plurality of pieces of third trusted measurement information, the fourth trusted measurement information, the plurality of pieces of fifth trusted measurement information, and the sixth trusted measurement information includes: determining the third trusted measurement information and the fifth trusted measurement information which correspond to each sub firmware; determining whether the third trusted measurement information and the fifth trusted measurement information which correspond to each sub firmware are consistent, to obtain a first comparison result; determining whether the fourth trusted measurement information and the sixth trusted measurement information are consistent, to obtain a second comparison result; and determining the verification result based on the first comparison result and the second comparison result.

In one exemplary embodiment, the determining the verification result based on the first comparison result and the second comparison result includes: in a case where the fifth trusted measurement information and the third trusted measurement information which correspond to each sub firmware are consistent, and the sixth trusted measurement information and the fourth trusted measurement information are consistent, determining that the verification result indicates that the verification on the first trusted measurement information succeeds; and in a case where the fifth trusted measurement information and the third trusted measurement information which correspond to any sub firmware in the target firmware are not consistent, and/or, the sixth trusted measurement information and the fourth trusted measurement information are not consistent, determining that the verification result indicates that the verification on the first trusted measurement information fails.

In one exemplary embodiment, the determining whether the third trusted measurement information and the fifth trusted measurement information which correspond to each sub firmware are consistent includes: determining whether to execute first sub firmware, wherein after the first sub firmware is executed, a memory resource of an in-band host system of the server is available; and in a case where the first sub firmware is executed, determining whether the third trusted measurement information and the fifth trusted measurement information which correspond to the first sub firmware are consistent, and determining whether the third trusted measurement information and the fifth trusted measurement information which correspond to second sub firmware are consistent, where the second sub firmware is another sub firmware other than the first sub firmware in the target firmware.

In one exemplary embodiment, the determining, based on the verification result, whether to execute the target firmware includes: executing the target firmware in a case where the verification result indicates that the verification on the first trusted measurement information succeeds; and in a case where the verification result indicates that the verification on the first trusted measurement information fails, prohibiting the execution of the target firmware, and transmitting warning information to a second terminal corresponding to the input/output system, wherein the second terminal is a terminal that manages the input/output system, and the warning information is configured to indicate that the target firmware is risky.

In one exemplary embodiment, the obtaining first trusted measurement information of the target firmware at least includes one of the following: obtaining metadata of the target firmware and determining the first trusted measurement information of the target firmware based on the metadata, wherein the metadata at least includes one of the following: creation time, modification time, and a file size; obtaining a permission setting of the target firmware and determining the first trusted measurement information of the target firmware based on the permission setting, wherein a permission corresponding to the permission setting includes: a read permission, a write permission, and an execution permission; obtaining source information of the target firmware and a transmission path of the target firmware, and determining the first trusted measurement information of the target firmware based on the source information and the transmission path; obtaining a digital digest of the target firmware and determining the first trusted measurement information of the target firmware based on the digital digest.

In one exemplary embodiment, the performing digital signature verification on target firmware of an input/output system includes: obtaining a digital certificate and a first digital signature that corresponding to the target firmware, wherein the digital certificate carries a public key, and the first digital signature is generated by the first terminal signing the target firmware based on the public key; signing the target firmware based on the public key to obtain a second digital signature of the target firmware; and performing digital signature verification on the target firmware of the input/output system based on the first digital signature and the second digital signature.

In one exemplary embodiment, the performing digital signature verification on the target firmware of the input/output system based on the first digital signature and the second digital signature includes: in a case where the first digital signature and the second digital signature are consistent, determining that the digital signature verification on the target firmware succeeds; and in a case where the first digital signature and the second digital signature are not consistent, determining that the digital signature verification on the target firmware fails.

In one exemplary embodiment, the performing digital signature verification on target firmware of an input/output system includes: obtaining a digital certificate corresponding to the target firmware and a first digital digest signature corresponding to the target firmware, wherein the digital certificate carries a public key; the first digital digest signature is generated by the first terminal signing a first digital digest corresponding to the target firmware; the first digital digest is generated by the first terminal performing a hash operation on the target firmware; performing the hash operation on the target firmware to obtain a second digital digest, and signing the second digital digest based on the public key to obtain a second digital digest signature; and performing digital signature verification on the target firmware of the input/output system based on the first digital digest signature and the second digital digest signature.

In one exemplary embodiment, the performing digital signature verification on the target firmware of the input/output system based on the first digital digest signature and the second digital digest signature includes: in a case where the first digital digest signature and the second digital digest signature are consistent, determining that the digital signature verification on the target firmware succeeds; and in a case where the first digital digest signature and the second digital digest signature are not consistent, determining that the digital signature verification on the target firmware fails.

In one exemplary embodiment, before the obtaining first trusted measurement information of the target firmware, the method further includes: determining whether the first trusted measurement information is obtained; and in a case where the first trusted measurement information is not obtained, transmitting warning information to a second terminal corresponding to the input/output system, wherein the second terminal is a terminal that manages the input/output system, and the warning information is used to indicate that the target firmware is risky.

In one exemplary embodiment, after the obtaining first trusted measurement information of the target firmware, the method further includes: performing digital signature verification on the first trusted measurement information through the trusted platform module of the server, where the server is a terminal loaded with the input/output system; in a case where the digital signature verification on the first trusted measurement information succeeds, determining verification result of verification on the first trusted measurement information; and in a case where the digital signature verification on the first trusted measurement information fails, transmitting warning information to a second terminal corresponding to the input/output system, wherein the second terminal is a terminal that manages the input/output system, and the warning information is used to indicate that the target firmware is risky.

In one exemplary embodiment, the performing digital signature verification on target firmware of an input/output system at least includes one of the following: performing digital signature verification on the target firmware of the input/output system through the trusted platform module of the server, where the server is a terminal loaded with the input/output system; performing digital signature verification on the target firmware of the input/output system through the board management controller of the server.

In one exemplary embodiment, the determining a verification result of verification on the first trusted measurement information includes: determining the verification result of the verification on the first trusted measurement information through the board management controller of the server, where the server is a terminal loaded with the input/output system.

According to another embodiment of the present application, an apparatus of executing firmware is provided, including: a first verification module, configured to perform digital signature verification on target firmware of an input/output system; a second verification module, configured to, in a case where the digital signature verification on the target firmware succeeds, obtain first trusted measurement information of the target firmware and determine a verification result of verification on the first trusted measurement information; and a determining module, configured to determine, based on the verification result, whether to execute the target firmware.

According to another embodiment of the present application, a firmware execution system is provided, including: a trusted platform module, configured to perform digital signature verification on target firmware of an input/output system; a board management controller, configured to, in a case where the digital signature verification on the target firmware succeeds, obtain first trusted measurement information of the target firmware and determine a verification result of verification on the first trusted measurement information; and a central processing unit, configured to determine, based on the verification result, whether to execute the target firmware.

According to still another embodiment of the present application, a non-volatile computer-readable storage medium is further provided. The non-volatile computer-readable storage medium stores a computer program, when the computer program is executed by a processor, steps of the method according to any one of the above method are implemented.

According to yet still another embodiment of the present application, an electronic device is further provided, including a memory and a processor. When the processor executes the computer program, steps of the method according to any one of the above method are implemented.

Through the present application, the digital signature verification is performed on the target firmware of the input/output system, so that in a case that the digital signature verification on the target firmware succeeds, the trusted measurement information verification is performed on the target firmware by obtaining the first trusted measurement information of the target firmware. Whether to execute the target firmware is determined based on the verification result of the first trusted measurement information. That is, the present application performs dual verification, namely the digital signature verification on the target firmware and the verification on the trusted measurement information, to determine whether the firmware is tampered with. In a case that the verification succeeds, the input/output system is started. Therefore, the following problem in the existing art can be solved: a verification mode for firmware of the input/output system is relatively simple and still has a risk of undetected firmware tampering, which poses a security risk to the server. An effect of improving the security of the server is achieved.

### BRIEF DESCRIPTION OF THE DRAWINGS

FIG. 1 is a block structural diagram of hardware of a server device of a method of executing firmware according to an embodiment of the present application;

FIG. 2 is a flowchart of a method of executing firmware according to an embodiment of the present application;

FIG. 3 is a schematic diagram of hardware of a trusted-verification-based firmware upgrading method according to an embodiment of the present application;

FIG. 4 is a flowchart of a trusted-verification-based firmware upgrading method according to an embodiment of the present application; and

FIG. 5 is a structural block diagram of an apparatus of executing firmware according to an embodiment of the present application.

### DETAILED DESCRIPTION OF THE EMBODIMENTS

The embodiments of the present application will be described in detail below with reference to the accompanying drawings and the embodiments.

The terms “first”, “second”, etc. in the specification and claims of this application and the above accompanying drawings are defined to distinguish similar objects, and do not have to be used to describe a specific order or sequence.

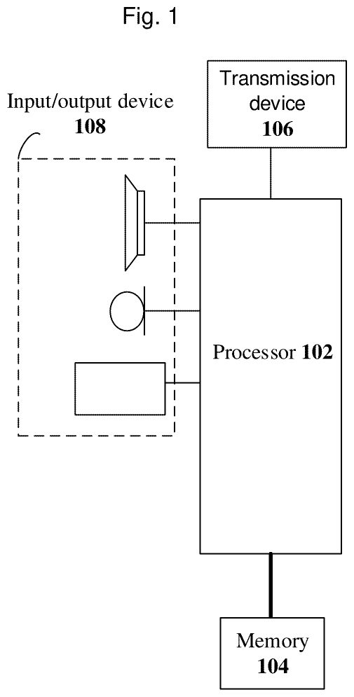

A method embodiment provided in the embodiments of the present application may be performed on a server device or a similar arithmetic device. An example in which the method embodiment is run on the server device is used. FIG. 1 is a block structural diagram of hardware of a server device of a method of executing firmware according to an embodiment of the present application. As shown in FIG. 1, the server device may include one or more processors 102 (only one processor is shown in FIG. 1) (the processor 102 may include, but is not limited to, a micro processing unit (MCU), a field programmable gate array (FPGA), and other processing apparatuses) and a memory 104 configured to store data. The above server device may further include a transmission device 106 with a communication function and an input/output device 108 with a communication function. A person of ordinary skill in the art can understood that the structures shown in FIG. 1 are only illustrative, and FIG does not constitute a limitation on the structures of the above server device. For example, the server device can further include more or fewer assemblies than those shown in FIG. 1, or have configurations different from those shown in FIG. 1.

The memory 104 may be configured to store a computer program, for example, a software program and a module of application software, such as a computer program corresponding to the method in the embodiments of the present application. The processor 102 executes various functional applications and data processing by executing the computer program stored in the memory 104, to implement the above method. The memory 104 may include high-speed random access memory and may also include a non-volatile memory, such as one or more magnetic storage apparatuses, a flash memory, or other non-volatile solid state memories. In some embodiments, the memory 104 can further include memories remotely located with respect to the processor 102. These remote memories can be connected to the server device through a network. Examples of the above network include, but are not limited to, Internets, intranets, local area networks, mobile communication networks, and combinations thereof.

The transmission device 106 is configured to receive or transmit data through a network. The examples of the above network may include a wireless network provided by a communication provider of the server device. In one embodiment, the transmission device 106 includes a network interface controller (NIC) that can be connected to other network devices through a base station for communication with the Internet. In one embodiment, the transmission device 106 may be a radio frequency (RF) module configured to communicate with the Internet in a radio manner.

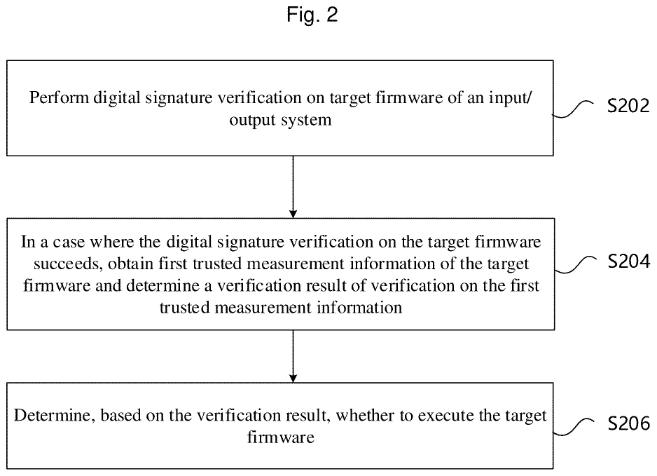

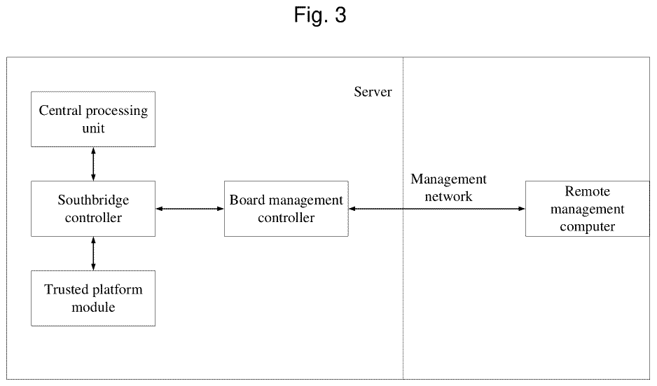

This embodiment provides a method of executing firmware. FIG. 2 is a flowchart of a method of executing firmware according to an embodiment of the present application. The method is applied to the server device of FIG. 1. As shown in FIG. 3, the server includes: a central processing unit, a southbridge controller connected to the central processing unit, a trusted platform module connected to the southbridge controller, and a board management controller connected to the southbridge controller. As shown in FIG. 2, the flow includes the following steps:

Step S202: Perform digital signature verification on target firmware of an input/output system.

The digital signature verification is first verification that has been performed on the target firmware. Step S202 is performed through the trusted platform module in the server or a trusted platform module in the board management controller.

Step S204: In a case where the digital signature verification on the target firmware succeeds, obtain first trusted measurement information of the target firmware, and determine a verification result of verification on the first trusted measurement information.

Step S204 is performed by the board management controller in the server.

That is, in a case where the first verification succeeds, second verification is performed on the target firmware, namely, trusted measurement information verification is performed on the target firmware.

Performing trusted measurement information verification on BIOS firmware (i.e. the target firmware of the present application) means a process of evaluating and verifying the BIOS firmware, to ensure reliability and security of the BIOS firmware. The first trusted measurement information can be determined based on at least one of the following: a BIOS firmware version number, BIOS firmware manufacturer information, and the like. In a case of executing the firmware, the first trusted measurement information can be generated based on the above information.

Step S206: Determine, based on the verification result, whether to execute the target firmware.

Step S206 is performed by the board management controller in the server.

Through the above steps, the digital signature verification is performed on the target firmware of the input/output system. In a case that the digital signature verification on the target firmware succeeds, the trusted measurement information verification is performed on the target firmware by obtaining the first trusted measurement information of the target firmware. Whether to execute the target firmware is determined based on the verification result of the first trusted measurement information. That is, the present application performs dual verification, namely the digital signature verification on the target firmware and the verification on the trusted measurement information, to determine whether the firmware is tampered with. In a case that the verification succeeds, the input/output system is started. Therefore, the following problem in the existing art can be solved: a verification mode for firmware of the input/output system is relatively simple and still has a risk of undetected firmware tampering, which poses a security risk to the server. An effect of improving the security of the server is achieved.

Optionally, the determining a verification result of verification on the first trusted measurement information includes: determining whether the first trusted measurement information and second trusted measurement information generated by a first terminal are consistent, wherein the second trusted measurement information is generated by the first terminal based on the target firmware; and determining the verification result based on whether the first trusted measurement information and the second trusted measurement information are consistent.

Optionally, the determining the verification result based on whether the first trusted measurement information and the second trusted measurement information are consistent includes: in a case where the first trusted measurement information and the second trusted measurement information are consistent, determining that the verification result indicates that the verification on the first trusted measurement information succeeds; and in a case where the first trusted measurement information and the second trusted measurement information are not consistent, determining that the verification result indicates that the verification on the first trusted measurement information fails.

It can be understood that whether the verification on the first trusted measurement information succeeds can be determined by determining whether the first trusted measurement information and the second trusted measurement information generated by the first terminal are consistent. Only in a case where the first trusted measurement information and the second trusted measurement information are consistent, it can be determined that verification on the first trusted measurement information succeeds. The first terminal may be a terminal corresponding to a server manufacturer.

In a case where the digital signature verification on the target firmware succeeds, the technical solution of verifying the first trusted measurement through can improve the protection capability of a BIOS against malicious software and attacks, and improve the security and trustworthiness of the BIOS.

Step S204 of obtaining first trusted measurement information of the target firmware may also be performed by the following technical solution: obtaining a plurality of pieces of third trusted measurement information, which comprise third trusted measurement information of each sub firmware in the target firmware, and fourth trusted measurement information of the target firmware as a whole, wherein the first trusted measurement information includes the plurality of pieces of the third trusted measurement information and the fourth trusted measurement information; the each sub firmware is partial firmware in the target firmware; and the each sub firmware is configured to execute one function.

In the process of obtaining the first trusted measurement information of the target firmware, a plurality of pieces of third trusted measurement information, which comprise third trusted measurement information of each sub firmware in the target firmware and the fourth trusted measurement information of the target firmware as a whole can also be obtained.

The fourth trusted measurement information of the target firmware as a whole is determined based on one of the following: version information, a security tag, a digital digest, and other information.

Sub firmware of the target firmware includes but is not limited to: Bootloader, Kernel, File system, Device drivers, Applications, Configuration files, Libraries, and the like. The sub firmware can jointly form the target firmware.

Each sub firmware has a corresponding function. For example: Bootloader is responsible for booting the BIOS and initializing the BIOS when the device is started. Kernel is a core part of the BIOS and is responsible for managing BIOS resources, providing basic functions, and the like. No examples will be given here one by one.

Through the above technical solution, the trusted measurement information verification is performed on not only the target firmware as a whole, but also parts inside the target firmware. This can ensure that each sub firmware in the target firmware is trustworthy and has not been maliciously tampered with, thereby improving the security of the BIOS.

Optionally, the determining a verification result of verification on the first trusted measurement information includes: determining a plurality of pieces of fifth trusted measurement information and six trusted measurement information from the second trusted measurement information generated by a first terminal, wherein the plurality of pieces of fifth trusted measurement information comprise fifth trusted measurement information generated by the first terminal based on the each sub firmware in the target firmware, and the sixth trusted measurement information is generated by the first terminal based on the target firmware as a whole; and determining the verification result based on the plurality of pieces of third trusted measurement information, the fourth trusted measurement information, the plurality of pieces of fifth trusted measurement information, and the sixth trusted measurement information.

Optionally, the determining the verification result based on the plurality of pieces of third trusted measurement information, the fourth trusted measurement information, the plurality of pieces of fifth trusted measurement information, and the sixth trusted measurement information includes: determining the third trusted measurement information and the fifth trusted measurement information which correspond to the each sub firmware; determining whether the third trusted measurement information and the fifth trusted measurement information which correspond to each sub firmware are consistent, to obtain a first comparison result; determining whether the fourth trusted measurement information and the sixth trusted measurement information are consistent, to obtain a second comparison result; and determining the verification result based on the first comparison result and the second comparison result.

Optionally, the determining the verification result based on the first comparison result and the second comparison result includes: in a case where the fifth trusted measurement information and the third trusted measurement information which correspond to each sub firmware are consistent, and the sixth trusted measurement information and the fourth trusted measurement information are consistent, determining that the verification result indicates that the verification on the first trusted measurement information succeeds; and in a case where the fifth trusted measurement information and the third trusted measurement information which correspond to any sub firmware in the target firmware are not consistent, and/or, the sixth trusted measurement information and the fourth trusted measurement information are not consistent, determining that the verification result indicates that the verification on the first trusted measurement information fails.

After the plurality of pieces of third trusted measurement information and the fourth trusted measurement information are obtained, the plurality of pieces of fifth trusted measurement information comprising fifth trusted measurement information generated by each sub firmware of the target firmware and the sixth trusted measurement information generated by the target firmware as a whole need to be determined based on the second trusted measurement information. The third trusted measurement information and the fifth trusted measurement information which correspond to the each sub firmware are compared to determine whether the third trusted measurement information and the fifth trusted measurement information which correspond to the each sub firmware are consistent, to obtain the first comparison result. The fourth trusted measurement information is compared with the sixth trusted measurement information to determine whether the fourth trusted measurement information and the sixth trusted measurement information are consistent, to obtain the second comparison result. That the verification on the first trusted measurement information succeeds can be determined only in a case where the first comparison result shows that the third trusted measurement information and the fifth trusted measurement information which correspond to the each sub firmware are consistent and the second comparison result shows that the fourth trusted measurement information and the sixth trusted measurement information are consistent. On the contrary, that the verification on the first trusted measurement information fails can be determined only in a case that the first comparison result shows that the third trusted measurement information and the fifth trusted measurement information which correspond to the each sub firmware are not consistent, and/or the second comparison result shows that the fourth trusted measurement information and the sixth trusted measurement information are not consistent.

The above technical solution performs trusted measurement information verification on the parts and the whole of the target firmware. That the verification on the first trusted measurement information succeeds can be determined only in a case that the trusted measurement information verification on the parts and the whole of the target firmware succeeds. Through the above technical solution, the integrity and trustworthiness of the target firmware are ensured, which prevents the target firmware from being tampered with or implanted with malicious codes. This ensures the security and stability of the target firmware and also improves the trustworthiness of the target firmware.

Optionally, the determining whether the third trusted measurement information and the fifth trusted measurement information that correspond to each sub firmware are consistent includes: determining whether to execute first sub firmware, where after the first sub firmware is executed, a memory resource of an in-band host system of the server is available; and in a case where the first sub firmware is executed, determining whether the third trusted measurement information and the fifth trusted measurement information which correspond to the first sub firmware are consistent, and determining whether the third trusted measurement information and the fifth trusted measurement information which correspond to second sub firmware are consistent, wherein the second sub firmware is another sub firmware other than the first sub firmware in the target firmware.

It can be understood that in a case where the first firmware is executed, the memory resource of the in-band host system of the server is available, and then the trusted measurement information of the target firmware can be verified through the memory resource. Optionally, in a case where the first sub firmware is executed, whether the third trusted measurement information and the fifth trusted measurement information which correspond to the first sub firmware of the target firmware are consistent is determined. In a case where the third trusted measurement information and the fifth trusted measurement information which correspond to the first sub firmware are consistent are not consistent, namely, in a case where the verification on the first sub firmware fails, the execution of the first sub firmware needs to be prohibited. In a case where the verification on the first sub firmware succeeds, whether the third trusted measurement information and the fifth trusted measurement information which correspond to the second firmware are consistent is determined. The above steps are cyclically performed until it is determined whether the verification on all sub firmware in the target firmware succeeds.

Optionally, the determining, based on the verification result, whether to execute the target firmware includes: executing the target firmware in a case where the verification result indicates that the verification on the first trusted measurement information succeeds; and in a case where the verification result indicates that the verification on the first trusted measurement information fails, prohibiting the execution of the target firmware, and transmitting warning information to a second terminal corresponding to the input/output system, where the second terminal is a terminal that manages the input/output system, and the warning information is used to indicate that the target firmware is risky.

Whether to execute the target firmware is determined based on the verification result after the verification result of the first trusted measurement information is determined. Optionally, in a case where the verification on the first trusted measurement information succeeds, the target firmware can be executed. In a case where the verification on the first trusted measurement information fails, the execution of the target firmware is prohibited, and the warning information indicating that the target firmware is risky is transmitted to the second terminal corresponding to the input/output system.

That is, the target firmware can be executed only in a case where the verification on the first trusted measurement information succeeds. It is determined that the target firmware is risky in a case that the verification on the first trusted measurement information fails. Through this technical solution, monitoring on the target firmware can be enhanced; the security protection capability can be improved; and potential risks can be effectively reduced.

Optionally, the obtaining first trusted measurement information of the target firmware at least includes one of the following: obtaining metadata of the target firmware and determining the first trusted measurement information of the target firmware based on the metadata, wherein the metadata at least includes one of the following: creation time, modification time, and a file size; obtaining a permission setting of the target firmware and determining the first trusted measurement information of the target firmware based on the permission setting, wherein a permission corresponding to the permission setting includes: a read permission, a write permission, and an execution permission; obtaining source information and a transmission path of the target firmware, and determining the first trusted measurement information of the target firmware based on the source information and the transmission path; obtaining a digital digest of the target firmware and determining the first trusted measurement information of the target firmware based on the digital digest.

There are many modes for determining the first trusted measurement information, including but not limited to: 1) determining the first trusted measurement information based on the metadata; 2) determining the first trusted measurement information based on the permission setting of the target firmware; 3) determining the first trusted measurement information based on the source information and transmission path of the target firmware; and 4) determining the first trusted measurement information based on the digital digest of the target firmware.

After the first trusted measurement information of the target firmware is obtained through the above mode, the technical solution of verifying the first trusted measurement information of the target firmware can be executed.

Optionally, the performing digital signature verification on target firmware of an input/output system includes: obtaining a digital certificate and a first digital signature that corresponding to the target firmware, wherein the digital certificate carries a public key, and the first digital signature is generated by the first terminal signing the target firmware based on the public key; signing the target firmware based on the public key to obtain a second digital signature of the target firmware; and performing digital signature verification on the target firmware of the input/output system based on the first digital signature and the second digital signature.

Optionally, the performing digital signature verification on the target firmware of the input/output system based on the first digital signature and the second digital signature includes: in a case where the first digital signature and the second digital signature are consistent, determining that the digital signature verification on the target firmware succeeds; and in a case where the first digital signature and the second digital signature are not consistent, determining that the digital signature verification on the target firmware fails.

This embodiment of the present application performs digital signature verification and trusted measurement information verification on the target firmware, so that the security of the target firmware is determined through the dual verification. Where a method for performing the digital signature verification on the target firmware can be obtaining a digital certificate and a first digital signature which correspond to the target firmware. That is, the digital certificate of the target firmware is obtained, and the first digital signature of the target firmware can be obtained by combining the public key carried in the digital certificate with a digital signature algorithm. After the first digital signature is obtained, the target firmware can be signed through the public key to obtain the second digital signature. The first digital signature and the second digital signature can be verified. In a case where the first digital signature and the second digital signature are consistent, it can be determined that the verification on the target firmware succeeds. In a case where the first digital signature and the second digital signature are not consistent, it can be determined that the verification on the target firmware fails.

The method for performing the digital signature verification on the target firmware can ensure the integrity and authenticity of the target firmware to prevent unauthorized modification and tampering. In this way, the security and stability of the input/output system can be ensured.

Optionally, the performing digital signature verification on target firmware of an input/output system includes: obtaining a digital certificate and a first digital digest signature which correspond to the target firmware, wherein the digital certificate carries a public key, the first digital digest signature is generated by the first terminal signing a first digital digest corresponding to the target firmware, the first digital digest is generated by the first terminal performing a hash operation on the target firmware; performing the hash operation on the target firmware to obtain a second digital digest, and signing the second digital digest based on the public key to obtain a second digital digest signature; and performing digital signature verification on the target firmware of the input/output system based on the first digital digest signature and the second digital digest signature.

Optionally, the performing digital signature verification on the target firmware of the input/output system based on the first digital digest signature and the second digital digest signature includes: in a case where the first digital digest signature and the second digital digest signature are consistent, determining that the digital signature verification on the target firmware succeeds; and in a case where the first digital digest signature and the second digital digest signature are not consistent, determining that the digital signature verification on the target firmware fails.

It can be understood that the digital digest of the target firmware can be verified to determine whether the digital signature verification on the target firmware succeeds. Optionally, the digital certificate of the target firmware is obtained, and the public key is determined based on the digital certificate. The first digital digest of the target firmware is generated by performing the hash operation on the target firmware by the first terminal. The first digital digest signature can be obtained by the first terminal signing the first digital digest of the target firmware.

After the first digital digest signature, the hash operation is performed on the target firmware to obtain the second digital digest, and the second digital digest is signed based on the public key carried by the digital certificate to obtain the second digital digest signature.

The obtained first digital digest signature and the obtained second digital digest signature are compared. In a case where the first digital digest signature and the second digital digest signature are consistent, it can be determined that the digital signature verification on the target firmware succeeds. In a case where the first digital digest signature and the second digital digest signature are not consistent, it can be determined that the digital signature verification on the target firmware fails.

By obtaining the first digital digest signature and the second digital digest signature of the target firmware, and determining, based on whether the digital digest signatures are consistent, whether the digital signature verification succeeds, the integrity and authenticity of data of the target firmware can be verified. This ensures that the target firmware has not been tampered with and modified during transmission and storage.

Optionally, before the obtaining first trusted measurement information of the target firmware, the method further includes: determining whether the first trusted measurement information is obtained; and in a case where the first trusted measurement information is not obtained, transmitting warning information to a second terminal corresponding to the input/output system, wherein the second terminal is a terminal that manages the input/output system, and the warning information is used to indicate that the target firmware is risky.

It can be understood that in a case that no first trusted measurement information is obtained, it can be considered that the target firmware is risky, and the warning information is transmitted to the second terminal.

Optionally, after the obtaining first trusted measurement information of the target firmware, the method further includes: performing digital signature verification on the first trusted measurement information through the trusted platform module of the server; in a case where the digital signature verification on the first trusted measurement information succeeds, determining verification result of verification on the first trusted measurement information; and in a case where the digital signature verification on the first trusted measurement information fails, transmitting warning information to a second terminal corresponding to the input/output system, where the second terminal is a terminal that manages the input/output system, and the warning information is used to indicate that the target firmware is risky.

It can be understood that the digital signature verification is first performed on the target firmware. In a case where the digital signature verification succeeds, the trusted measurement verification can be performed on the target firmware, and the verification result is obtained. In a case where the digital signature verification fails, the warning information is directly transmitted to the second terminal, so that it is determined that the target firmware is risky, and the trusted measurement verification is not performed on the target firmware.

Optionally, the performing digital signature verification on target firmware of an input/output system at least includes one of the following: performing digital signature verification on the target firmware of the input/output system through the trusted platform module of the server; performing digital signature verification on the target firmware of the input/output system through the board management controller of the server.

There are many modes for performing the digital signature verification on the target firmware, for example: performing the digital signature verification on the target firmware through the trusted platform of the server; or performing the digital signature verification on the target firmware through the board management controller of the server.

Optionally, the determining a verification result of verification on the first trusted measurement information includes: determining the verification result of the verification on the first trusted measurement information through the board management controller of the server.

According to the descriptions in the above implementations, a person skilled in the art may clearly learn that the method according to the foregoing embodiments may be implemented by relying on software and an essential commodity hardware platform or by using hardware, but the former is a better implementation in most cases. Based on such an understanding, the technical solutions of present application essentially, or the part contributing to the existing art, may be presented in the form of a software product. The computer software product is stored in a non-volatile readable storage medium (e.g. a read-only memory/random access memory (ROM/RAM), a magnetic disk, or a compact disc) including several instructions to enable a terminal device (which may be a mobile phone, a computer, a server, a network device, or the like) to perform the methods described in all the embodiments of present application.

In order to better understand the process of the above method of executing firmware, an implementation flow of the method of executing firmware will be described below in conjunction with an optional embodiment, but it is not intended to limit the technical solutions of the embodiments of the present application.

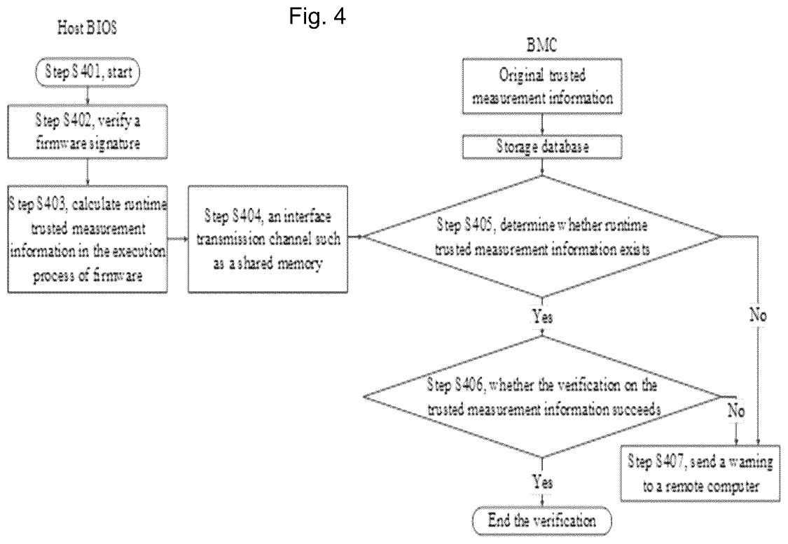

One embodiment of the present application provides a trusted-verification-based firmware upgrading method. FIG. 3 is a schematic diagram of hardware of a trusted-verification-based firmware upgrading method according to an embodiment of the present application. As shown in FIG. 3, one embodiment of the present application aims to transmit its own trusted measurement information to a BMC through a BIOS, to verify the integrity of BIOS firmware (i.e. the target firmware of the present application) based on the trusted measurement information, and a verification result is reported to a remote management computer, thus achieving a technical effect of preventing the BIOS firmware from being tampered with. Optionally, FIG. 4 is a flowchart of a trusted-verification-based firmware upgrading method according to an embodiment of the present application. As shown in FIG. 4:

Step S401, start.

A server manufacturer compiles BIOS firmware with a key signature. When the BIOS firmware is compiled, original trusted measurement information of parts in a mirror image of the BIOS firmware and original trusted measurement information (i.e. the first trusted measurement information of the present application) of the overall mirror image (excluding a dynamic region) can be generated.

The signed BIOS firmware and the trusted measurement information are allocated to a user of a server with a TPM. After receiving the signed BIOS firmware and the trusted measurement information, the user of the server uploads the trusted measurement information to a BMC of the server when upgrading the BIOS firmware. Meanwhile, a server host is shut down, and partial or entire BIOS firmware is refreshed. The server host is turned on after the refreshing.

Step S402, verify a firmware signature.

In a power-on self-test (POST) process, the BIOS uses the hardware TPM module to mirror the BIOS firmware to perform signature verification. After the signature verification succeeds, the BIOS firmware can be executed (i.e. the digital signature verification of the present application).

Step S403, calculate trusted measurement information of parts of a mirror image and the overall mirror image through the hardware TPM.

After the signature verification succeeds, the BIOS firmware mirroring is executed. The trusted measurement information (i.e. the second trusted measurement information of the present application) of the parts of the mirror image and the overall mirror image (excluding a dynamic region) are calculated by using the hardware TPM in the execution process.

Step S404, a BIOS transfers the runtime trusted measurement information obtained in step S403 to the BMC through an interface such as a shared memory.

Step S405, determine whether runtime measurement information exists.

The BMS determines whether the BIOS has uploaded the runtime trusted measurement information after startup. In a case that the runtime trusted measurement information is not uploaded, but the BIOS firmware has already been executed, step S407 is performed. In a case that the runtime trusted measurement information has been uploaded, step S406 is performed.

Step S406, verify the trusted measurement information.

The BMC uses the runtime trusted measurement information distributed synchronously with the BIOS firmware to verify the trusted measurement information uploaded by the BIOS in the power-on self-test process. In a case that the verification succeeds, the verification ends. In a case that the verification fails, step S407 is performed.

Step S407, send a warning to a remote computer (i.e. the second terminal of the present application).

In this case, it is determined that the BIOS firmware is no longer secure, and the warning is sent to the remote management computer.

One embodiment of the present application provides a verification method that can sense in real time whether firmware is damaged or tampered with, and can provide firmware mirror image integrity and prevent tampering even if a key is leaked. Through the above technical solution, it is convenient for use by server management and maintenance personnel. Meanwhile, without an expensive security controller such as an FPGA, the above technical solution uses the built-in TPM of the server to complete the verification on the BIOS firmware at lower costs. A relatively high firmware security verification mechanism is provided at lower costs and in a relatively simple manner.

In this embodiment, an apparatus of executing firmware is further provided. The apparatus is configured to implement the above embodiments and preferred embodiments. Those that have already been described will not be elaborated. As used below, the term “module” can be a combination of software and/or hardware that implements a predetermined function. Although the apparatus described in the following embodiments is preferably implemented in software, the implementation of hardware or a combination of software and hardware is also possible and envisioned.

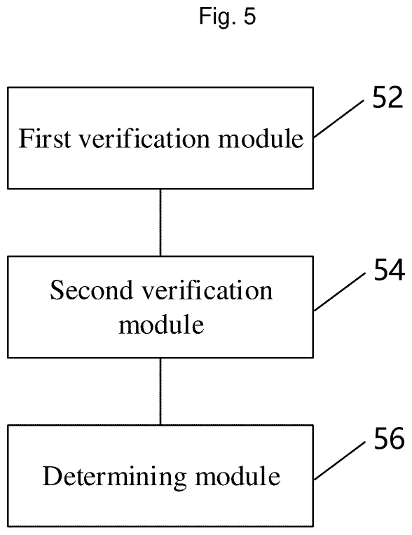

FIG. 5 is a structural block diagram of an apparatus of executing firmware according to an embodiment of the present application. As shown in FIG. 5, the apparatus includes:
a first verification module 52, configured to perform digital signature verification on target firmware of an input/output system;
a second verification module 54, configured to, in a case where the digital signature verification on the target firmware succeeds, obtain first trusted measurement information of the target firmware and determine a verification result of verification on the first trusted measurement information; and
a determining module 56, configured to determine, based on the verification result, whether to execute the target firmware.

Through the above apparatus, the digital signature verification is performed on the target firmware of the input/output system. In a case that the digital signature verification on the target firmware succeeds, the trusted measurement information verification is performed on the target firmware by obtaining the first trusted measurement information of the target firmware. Whether to execute the target firmware is determined based on the verification result of the first trusted measurement information. That is, the present application performs dual verification, namely the digital signature verification on the target firmware and the verification on the trusted measurement information, to determine whether the firmware is tampered with. In a case that the verification succeeds, the input/output system is started. Therefore, the following problem in the existing art can be solved: a verification mode for firmware of the input/output system is relatively simple and still has a risk of undetected firmware tampering, which poses a security risk to the server. An effect of improving the security of the server is achieved.

In one exemplary embodiment, the second verification module 54 is further configured to: determine whether the first trusted measurement information and second trusted measurement information generated by a first terminal are consistent, wherein the second trusted measurement information is generated by the first terminal based on the target firmware; and determine the verification result based on whether the first trusted measurement information and the second trusted measurement information are consistent.

In one exemplary embodiment, the second verification module 54 is further configured to, in a case where the first trusted measurement information and the second trusted measurement information are consistent, determine that the verification result indicates that the verification on the first trusted measurement information succeeds; and in a case where the first trusted measurement information and the second trusted measurement information are not consistent, determine that the verification result indicates that the verification on the first trusted measurement information fails.

In one exemplary embodiment, the second verification module 54 is further configured to obtain a plurality of pieces of third trusted measurement information, which comprise third trusted measurement information of each sub firmware in the target firmware, and fourth trusted measurement information of the target firmware as a whole, where the first trusted measurement information includes: the plurality of pieces of the third trusted measurement information and the fourth trusted measurement information; the each sub firmware is partial firmware in the target firmware; and the each sub firmware is configured to execute one function.

In one exemplary embodiment, the second verification module 54 is further configured to: determine a plurality of pieces of fifth trusted measurement information and six trusted measurement information from second trusted measurement information generated by a first terminal, wherein the plurality of pieces of fifth trusted measurement information comprise fifth trusted measurement information generated by the first terminal based on the each sub firmware in the target firmware, and the sixth trusted measurement information is generated by the first terminal based on the target firmware as a whole; and determine the verification result based on the plurality of pieces of third trusted measurement information, the fourth trusted measurement information, the plurality of pieces of fifth trusted measurement information, and the sixth trusted measurement information.

In one exemplary embodiment, the second verification module 54 is further configured to: determine the third trusted measurement information and the fifth trusted measurement information which correspond to each sub firmware; determine whether the third trusted measurement information and the fifth trusted measurement information which correspond to each sub firmware are consistent, to obtain a first comparison result; determine whether the fourth trusted measurement information and the sixth trusted measurement information are consistent, to obtain a second comparison result; and determine the verification result based on the first comparison result and the second comparison result.

In one exemplary embodiment, the second verification module 54 is further configured to, in a case where the fifth trusted measurement information and the third trusted measurement information which correspond to each sub firmware are consistent, and the sixth trusted measurement information and the fourth trusted measurement information are consistent, determine that the verification result indicates that the verification on the first trusted measurement information succeeds; and in a case where the fifth trusted measurement information and the third trusted measurement information which correspond to any sub firmware in the target firmware are not consistent, and/or, the sixth trusted measurement information and the fourth trusted measurement information are not consistent, determine that the verification result indicates that the verification on the first trusted measurement information fails.

In one exemplary embodiment, the second verification module 54 is further configured to: determine whether to execute first sub firmware, wherein after the first sub firmware is executed, a memory resource of an in-band host system of the server is available; and in a case where the first sub firmware is executed, determine whether the third trusted measurement information and the fifth trusted measurement information which correspond to the first sub firmware are consistent, and determine whether the third trusted measurement information and the fifth trusted measurement information that correspond to second sub firmware are consistent, where the second sub firmware is another sub firmware other than the first sub firmware in the target firmware.

In one exemplary embodiment, the determining module 56 is further configured to: execute the target firmware in a case where the verification result indicates that the verification on the first trusted measurement information succeeds; and in a case where the verification result indicates that the verification on the first trusted measurement information fails, prohibit the execution of the target firmware, and transmit warning information to a second terminal corresponding to the input/output system, wherein the second terminal is a terminal that manages the input/output system, and the warning information is used to indicate that the target firmware is risky.

In one exemplary embodiment, the second verification module 54 is further configured to: obtain metadata of the target firmware and determine the first trusted measurement information of the target firmware based on the metadata, wherein the metadata at least includes one of the following: creation time, modification time, and a file size; obtain a permission setting of the target firmware and determining the first trusted measurement information of the target firmware based on the permission setting, wherein a permission corresponding to the permission setting includes: a read permission, a write permission, and an execution permission; obtain source information and a transmission path of the target firmware, and determine the first trusted measurement information of the target firmware based on the source information and the transmission path; obtain a digital digest of the target firmware and determine the first trusted measurement information of the target firmware based on the digital digest.

In one exemplary embodiment, the first verification module 52 is further configured to: obtain a digital certificate and a first digital signature that correspond to the target firmware, where the digital certificate carries a public key, and the first digital signature is generated by the first terminal signing the target firmware based on the public key; sign the target firmware based on the public key to obtain a second digital signature of the target firmware; and perform digital signature verification on the target firmware of the input/output system based on the first digital signature and the second digital signature.

In one exemplary embodiment, the first verification module 52 is further configured to: in a case where the first digital signature and the second digital signature are consistent, determine that the digital signature verification on the target firmware succeeds; and in a case where the first digital signature and the second digital signature are not consistent, determine that the digital signature verification on the target firmware fails.

In one exemplary embodiment, the first verification module 52 is further configured to: obtain a digital certificate and a first digital digest signature that correspond to the target firmware, where the digital certificate carries a public key; the first digital digest signature is generated by the first terminal signing a first digital digest corresponding to the target firmware; the first digital digest is generated by the first terminal performing a hash operation on the target firmware; perform the hash operation on the target firmware to obtain a second digital digest, and sign the second digital digest based on the public key to obtain a second digital digest signature; and perform digital signature verification on the target firmware of the input/output system based on the first digital digest signature and the second digital digest signature.

In one exemplary embodiment, the first verification module 52 is further configured to: in a case where the first digital digest signature and the second digital digest signature are consistent, determine that the digital signature verification on the target firmware succeeds; and in a case where the first digital digest signature and the second digital digest signature are not consistent, determine that the digital signature verification on the target firmware fails.

In one exemplary embodiment, the first verification module 52 is further configured to: determine whether the first trusted measurement information is obtained; and in a case where the first trusted measurement information is not obtained, transmit warning information to a second terminal corresponding to the input/output system, wherein the second terminal is a terminal that manages the input/output system, and the warning information is used to indicate that the target firmware is risky.

In one exemplary embodiment, the second verification module 54 is further configured to: perform digital signature verification on the first trusted measurement information through the trusted platform module of the server; in a case where the digital signature verification on the first trusted measurement information succeeds, determine verification result of verification on the first trusted measurement information; and in a case where the digital signature verification on the first trusted measurement information fails, transmit warning information to a second terminal corresponding to the input/output system, where the second terminal is a terminal that manages the input/output system, and the warning information is used to indicate that the target firmware is risky.

In one exemplary embodiment, the first verification module 52 is further configured to: perform digital signature verification on the target firmware of the input/output system through the trusted platform module of the server; perform digital signature verification on the target firmware of the input/output system through the board management controller of the server.

In one exemplary embodiment, the determining module 56 is further configured to determine the verification result of the verification on the first trusted measurement information through the board management controller of the server.

It should be noted that the above modules can be implemented through software or hardware. For the latter, the various modules can be implemented in the following ways, but not limited to: The above modules are all located in the same processor; or, the aforementioned modules may be located in different processors in the form of any combination.

An embodiment of the present application further provides a system of executing firmware, including: a trusted platform module, configured to perform digital signature verification on target firmware of an input/output system; a board management controller, configured to, in a case where the digital signature verification on the target firmware succeeds, obtain first trusted measurement information of the target firmware and determine a verification result of verification on the first trusted measurement information; and a central processing unit, configured to determine, based on the verification result, whether to execute the target firmware.

An embodiment of the present application further provides a non-volatile computer-readable storage medium. The computer-readable storage medium has a computer program stored therein, and the computer program is configured to, when run, execute the steps in any one of the above method embodiments.

In an exemplary embodiment, the non-volatile computer-readable storage medium mentioned above can include but not limited to: various media that can store computer programs, such as a USB flash drive, a ROM, a RAM, a mobile hard disk drive, a magnetic disk, and a compact disc.

An embodiment of the present application further provides an electronic device, including a memory and a processor. The memory has a computer program stored therein. The processor is configured to run the computer program to execute the steps in any one of the above method embodiments.

In one exemplary embodiment, the electronic device may further include a transmission device and an input/output device, where the transmission device is connected to the above processor, and the input/output device is connected to the above processor.

The examples in this embodiment can be found in the examples described in the above embodiments and exemplary implementations, and will not be elaborated in this embodiment.

Obviously, those skilled in the art should understand that the various modules or steps of the present application can be implemented using a universal computing apparatus, which can be concentrated on a single computing apparatus or distributed on a network composed of a plurality of computing apparatuses. The modules or steps can be implemented using program codes that can be executed by a computing apparatus, so that the modules or steps can be stored in a storage apparatus for execution by the computing apparatus. Furthermore, in some cases, the steps shown or described can be executed in an order different from those here, or the steps can be separately made into various integrated circuit modules, or a plurality of modules or steps among the modules or steps can be made into single integrated circuit modules for implementation. In this way, the present application is not limited to any specific combinations of hardware and software.

The above descriptions are only optional embodiments of the present application, and are not intended to limit the present application. For those skilled in the art, the present application may have various modifications and changes. Any modification, equivalent replacement, and improvement made within the principles of the present application shall fall within the protection scope of the present application.

1. A method of executing firmware, applied to a server, wherein the server comprises: a central processing unit, a southbridge controller connected to the central processing unit, a trusted platform module connected to the southbridge controller, and a board management controller connected to the southbridge controller, and the method comprises:
performing digital signature verification on target firmware of an input/output system, wherein the input/output system is a system that is run in the central processing unit;
in a case where the digital signature verification on the target firmware succeeds, obtaining first trusted measurement information of the target firmware, and determining a verification result of verification on the first trusted measurement information; and
determining, based on the verification result, whether to execute the target firmware,
wherein the obtaining first trusted measurement information of the target firmware comprises: obtaining a plurality of pieces of third trusted measurement information, which comprise third trusted measurement information of each sub firmware in the target firmware, and fourth trusted measurement information of the target firmware as a whole, wherein the first trusted measurement information comprises: the plurality of pieces of the third trusted measurement information and the fourth trusted measurement information; the each sub firmware is partial firmware in the target firmware; and the each sub firmware is configured to execute one function;
wherein the determining a verification result of verification on the first trusted measurement information comprises: determining a plurality of pieces of fifth trusted measurement information and a sixth trusted measurement information from second trusted measurement information generated by a first terminal, wherein the plurality of pieces of the fifth trusted measurement information comprise fifth trusted measurement information generated by the first terminal based on the each sub firmware in the target firmware, and the sixth trusted measurement information is generated by the first terminal based on the target firmware as a whole; and determining the verification result based on the plurality of pieces of the third trusted measurement information, the fourth trusted measurement information, the plurality of pieces of the fifth trusted measurement information, and the sixth trusted measurement information;
wherein the determining the verification result based on the plurality of pieces of the third trusted measurement information, the fourth trusted measurement information, the plurality of pieces of the fifth trusted measurement information, and the sixth trusted measurement information comprises: determining the third trusted measurement information and the fifth trusted measurement information which correspond to the each sub firmware; determining whether the third trusted measurement information and the fifth trusted measurement information which correspond to the each sub firmware are consistent, to obtain a first comparison result; determining whether the fourth trusted measurement information and the sixth trusted measurement information are consistent, to obtain a second comparison result; and determining the verification result based on the first comparison result and the second comparison result;
wherein the determining whether the third trusted measurement information and the fifth trusted measurement information which correspond to the each sub firmware are consistent comprises: determining whether to execute first sub firmware, wherein after the first sub firmware is executed, a memory resource of an in-band host system of the server is available; and in a case where the first sub firmware is executed, determining whether the third trusted measurement information and the fifth trusted measurement information which correspond to the first sub firmware are consistent, and determining whether the third trusted measurement information and the fifth trusted measurement information which correspond to second sub firmware are consistent, wherein the second sub firmware is another sub firmware other than the first sub firmware in the target firmware.

2. The method according to claim 1, wherein the determining a verification result of verification on the first trusted measurement information comprises:
determining whether the first trusted measurement information and second trusted measurement information generated by a first terminal are consistent, wherein the second trusted measurement information is generated by the first terminal based on the target firmware; and
determining the verification result based on whether the first trusted measurement information and the second trusted measurement information are consistent.

3. The method according to claim 2, wherein the determining the verification result based on whether the first trusted measurement information and the second trusted measurement information are consistent comprises:
in a case where the first trusted measurement information and the second trusted measurement information are consistent, determining that the verification result indicates that the verification on the first trusted measurement information succeeds; and
in a case where the first trusted measurement information and the second trusted measurement information are not consistent, determining that the verification result indicates that the verification on the first trusted measurement information fails.

4-6. (canceled)

7. The method according to claim 1, wherein the determining the verification result based on the first comparison result and the second comparison result comprises:
in a case where the fifth trusted measurement information and the third trusted measurement information which correspond to the each sub firmware are consistent, and the sixth trusted measurement information and the fourth trusted measurement information are consistent, determining that the verification result indicates that the verification on the first trusted measurement information succeeds; and
in a case where the fifth trusted measurement information and the third trusted measurement information which correspond to any sub firmware in the target firmware are not consistent, and/or, the sixth trusted measurement information and the fourth trusted measurement information are not consistent, determining that the verification result indicates that the verification on the first trusted measurement information fails.

8. (canceled)

9. The method according to claim 1, wherein the determining, based on the verification result, whether to execute the target firmware comprises:
executing the target firmware in a case where the verification result indicates that the verification on the first trusted measurement information succeeds; and
in a case where the verification result indicates that the verification on the first trusted measurement information fails, prohibiting the execution of the target firmware, and transmitting warning information to a second terminal corresponding to the input/output system, wherein the second terminal is a terminal that manages the input/output system, and the warning information is configured to indicate that the target firmware is risky.

10. The method according to claim 1, wherein the obtaining first trusted measurement information of the target firmware at least comprises one of the following:
obtaining metadata of the target firmware and determining the first trusted measurement information of the target firmware based on the metadata, wherein the metadata at least comprises one of the following: creation time, modification time, and a file size;
obtaining a permission setting of the target firmware and determining the first trusted measurement information of the target firmware based on the permission setting, wherein a permission corresponding to the permission setting comprises: a read permission, a write permission, and an execution permission;
obtaining source information of the target firmware and a transmission path of the target firmware, and determining the first trusted measurement information of the target firmware based on the source information and the transmission path;
obtaining a digital digest of the target firmware and determining the first trusted measurement information of the target firmware based on the digital digest.

11. The method according to claim 1, wherein the performing digital signature verification on target firmware of an input/output system comprises:
obtaining a digital certificate corresponding to the target firmware and a first digital signature corresponding to the target firmware, wherein the digital certificate carries a public key, and the first digital signature is generated by the first terminal signing the target firmware based on the public key;
signing the target firmware based on the public key to obtain a second digital signature of the target firmware; and
performing digital signature verification on the target firmware of the input/output system based on the first digital signature and the second digital signature.

12. The method according to claim 11, wherein the performing digital signature verification on the target firmware of the input/output system based on the first digital signature and the second digital signature comprises:
in a case where the first digital signature and the second digital signature are consistent, determining that the digital signature verification on the target firmware succeeds; and
in a case where the first digital signature and the second digital signature are not consistent, determining that the digital signature verification on the target firmware fails.

13. The method according to claim 1, wherein the performing digital signature verification on target firmware of an input/output system comprises:
obtaining a digital certificate corresponding to the target firmware and a first digital digest signature corresponding to the target firmware, wherein the digital certificate carries a public key, the first digital digest signature is generated by the first terminal signing a first digital digest corresponding to the target firmware, the first digital digest is generated by the first terminal performing a hash operation on the target firmware;
performing the hash operation on the target firmware to obtain a second digital digest, and signing the second digital digest based on the public key to obtain a second digital digest signature; and
performing digital signature verification on the target firmware of the input/output system based on the first digital digest signature and the second digital digest signature.

14. The method according to claim 13, wherein the performing digital signature verification on the target firmware of the input/output system based on the first digital digest signature and the second digital digest signature comprises:
in a case where the first digital digest signature and the second digital digest signature are consistent, determining that the digital signature verification on the target firmware succeeds; and
in a case where the first digital digest signature and the second digital digest signature are not consistent, determining that the digital signature verification on the target firmware fails.

15. The method according to claim 1, wherein before the obtaining first trusted measurement information of the target firmware, the method further comprises:
determining whether the first trusted measurement information is obtained; and
in a case where the first trusted measurement information is not obtained, transmitting warning information to a second terminal corresponding to the input/output system, wherein the second terminal is a terminal that manages the input/output system, and the warning information is configured to indicate that the target firmware is risky.

16. The method according to claim 1, wherein after the obtaining first trusted measurement information of the target firmware, the method further comprises:
performing digital signature verification on the first trusted measurement information through the trusted platform module of the server;
in a case where the digital signature verification on the first trusted measurement information succeeds, determining verification result of verification on the first trusted measurement information; and
in a case where the digital signature verification on the first trusted measurement information fails, transmitting warning information to a second terminal corresponding to the input/output system, wherein the second terminal is a terminal that manages the input/output system, and the warning information is configured to indicate that the target firmware is risky.

17. The method according to claim 1, wherein the performing digital signature verification on target firmware of an input/output system at least comprises one of the following:
performing digital signature verification on the target firmware of the input/output system through the trusted platform module of the server;
performing digital signature verification on the target firmware of the input/output system through the board management controller of the server.

18. The method according to claim 1, wherein the determining a verification result of verification on the first trusted measurement information comprises:
determining the verification result of the verification on the first trusted measurement information through the board management controller of the server.

19. An apparatus of executing firmware, comprising:
a first verification module, configured to perform digital signature verification on target firmware of an input/output system;
a second verification module, configured to, in a case where the digital signature verification on the target firmware succeeds, obtain first trusted measurement information of the target firmware and determine a verification result of verification on the first trusted measurement information; and
a determining module, configured to determine, based on the verification result, whether to execute the target firmware;
wherein the second verification module is further configured to obtain first trusted measurement information of the target firmware by following steps: obtaining a plurality of pieces of third trusted measurement information, which comprise third trusted measurement information of each sub firmware in the target firmware, and fourth trusted measurement information of the target firmware as a whole, wherein the first trusted measurement information comprises: the plurality of pieces of the third trusted measurement information and the fourth trusted measurement information; the each sub firmware is partial firmware in the target firmware; and the each sub firmware is configured to execute one function;
wherein the second verification module is further configured to determine a verification result of verification on the first trusted measurement information by following steps: determining a plurality of pieces of fifth trusted measurement information and a sixth trusted measurement information from second trusted measurement information generated by a first terminal, wherein the plurality of pieces of the fifth trusted measurement information comprise fifth trusted measurement information generated by the first terminal based on the each sub firmware in the target firmware, and the sixth trusted measurement information is generated by the first terminal based on the target firmware as a whole; and determining the verification result based on the plurality of pieces of the third trusted measurement information, the fourth trusted measurement information, the plurality of pieces of the fifth trusted measurement information, and the sixth trusted measurement information;
wherein the second verification module is further configured to determine the verification result based on the plurality of pieces of the third trusted measurement information, the fourth trusted measurement information, the plurality of pieces of the fifth trusted measurement information, and the sixth trusted measurement information by following steps: determining the third trusted measurement information and the fifth trusted measurement information which correspond to the each sub firmware; determining whether the third trusted measurement information and the fifth trusted measurement information which correspond to the each sub firmware are consistent, to obtain a first comparison result; determining whether the fourth trusted measurement information and the sixth trusted measurement information are consistent, to obtain a second comparison result; and determining the verification result based on the first comparison result and the second comparison result;
wherein the second verification module is further configured to determine whether the third trusted measurement information and the fifth trusted measurement information which correspond to the each sub firmware are consistent by following steps: determining whether to execute first sub firmware, wherein after the first sub firmware is executed, a memory resource of an in-band host system of the server is available; and in a case where the first sub firmware is executed, determining whether the third trusted measurement information and the fifth trusted measurement information which correspond to the first sub firmware are consistent, and determining whether the third trusted measurement information and the fifth trusted measurement information which correspond to second sub firmware are consistent, wherein the second sub firmware is another sub firmware other than the first sub firmware in the target firmware.

20. A system of executing firmware, comprising:
a trusted platform module, configured to perform digital signature verification on target firmware of an input/output system;
a board management controller, configured to, in a case where the digital signature verification on the target firmware succeeds, obtain first trusted measurement information of the target firmware and determine a verification result of verification on the first trusted measurement information; and
a central processing unit, configured to determine, based on the verification result, whether to execute the target firmware;
wherein the board management controller is further configured to obtain first trusted measurement information of the target firmware by following steps: obtaining a plurality of pieces of third trusted measurement information, which comprise third trusted measurement information of each sub firmware in the target firmware, and fourth trusted measurement information of the target firmware as a whole, wherein the first trusted measurement information comprises: the plurality of pieces of the third trusted measurement information and the fourth trusted measurement information; the each sub firmware is partial firmware in the target firmware; and the each sub firmware is configured to execute one function;
wherein the board management controller is further configured to determine a verification result of verification on the first trusted measurement information by following steps: determining a plurality of pieces of fifth trusted measurement information and a sixth trusted measurement information from second trusted measurement information generated by a first terminal, wherein the plurality of pieces of the fifth trusted measurement information comprise fifth trusted measurement information generated by the first terminal based on the each sub firmware in the target firmware, and the sixth trusted measurement information is generated by the first terminal based on the target firmware as a whole; and determining the verification result based on the plurality of pieces of the third trusted measurement information, the fourth trusted measurement information, the plurality of pieces of the fifth trusted measurement information, and the sixth trusted measurement information;
wherein the board management controller is further configured to determine the verification result based on the plurality of pieces of the third trusted measurement information, the fourth trusted measurement information, the plurality of pieces of the fifth trusted measurement information, and the sixth trusted measurement information by following steps: determining the third trusted measurement information and the fifth trusted measurement information which correspond to the each sub firmware; determining whether the third trusted measurement information and the fifth trusted measurement information which correspond to the each sub firmware are consistent, to obtain a first comparison result; determining whether the fourth trusted measurement information and the sixth trusted measurement information are consistent, to obtain a second comparison result; and determining the verification result based on the first comparison result and the second comparison result;
wherein the board management controller is further configured to determine whether the third trusted measurement information and the fifth trusted measurement information which correspond to the each sub firmware are consistent by following steps: determining whether to execute first sub firmware, wherein after the first sub firmware is executed, a memory resource of an in-band host system of the server is available; and in a case where the first sub firmware is executed, determining whether the third trusted measurement information and the fifth trusted measurement information which correspond to the first sub firmware are consistent, and determining whether the third trusted measurement information and the fifth trusted measurement information which correspond to second sub firmware are consistent, wherein the second sub firmware is another sub firmware other than the first sub firmware in the target firmware.

21. A non-volatile computer-readable storage medium, wherein the non-volatile computer-readable storage medium stores a computer program, when the computer program is executed by a processor, steps of the method according to claim 1 is implemented.

22. An electronic device, comprising a memory, a processor, and a computer program stored on the memory and executable on the processor, wherein when the processor executes the computer program, steps of the method according to claim 1 is implemented.
